(19) United States
(12) Patent Application Publication
(10) Pub. No.: US 2026/0298773 A1
(43) Pub. Date: Oct. 1, 2026

(54) DIAGNOSIS SYSTEM FOR VEHICLE COMPONENTS

(71) Applicant: MAGIC ENGINEERING SRL, PARTINICO (IT)

(72) Inventor: Tomasz ORLOWSKI, Partinico (IT)

(73) Assignee: MAGIC ENGINEERING SRL, PARTINICO (IT)

(21) Appl. No.: 19/100,926

(22) PCT Filed: Aug. 2, 2023
(86) PCT No.: PCT/IB2023/057825

§ 371 Date: Feb. 3, 2025

(30) Foreign Application Priority Data
Aug. 4, 2022 (IT) 102022000016728

(51) Int. Cl. G01M 17/007; H04R 1/40; H04R 17/02

(52) U.S. Cl. CPC G01M 17/007; H04R 1/406; H04R 17/02; H04R 2201/003; H04R 2201/403

(57) ABSTRACT

A system for sound and ultrasonic analysis of vehicle components comprises measuring means for measuring one or more parameters relating to the operation of the components of the vehicle to be tested, said measuring means being suitable for carrying out the measurements without contact with the components to be tested, processing means suitable for processing the signals provided by said measuring means and producing the related data, a camera suitable for being positioned above said components to be tested to detect in real time signal sources to be superimposed on the image and to show the relevant data on a display.

### TECHNICAL FIELD

The present invention concerns the technical field of automotive measurement systems and, in particular, refers to a diagnosis system for vehicle components that uses sound and ultrasound analysis, such as the analysis carried out during vehicle tests on dynamometer.

### STATE OF THE ART

The known systems for detecting mechanical problems or faults generally operate through the use of tools which detects any faults specifically for each component to be monitored.

From a technical point of view, it is possible to use different solutions, such as probes, sound systems and the like, but always acting in a localized manner.

These operating methods are therefore limited in that they require long times and are not entirely efficient, as they do not allow for an immediate and complete picture of the critical issues, often leading to an incomplete diagnosis.

### SCOPE OF THE INVENTION

The object of the present invention is to overcome the above drawbacks by providing a diagnosis system for vehicle components that is particularly effective and efficient.

A particular object is to provide a diagnostic system that allow to quickly identify and prioritize mechanical problems through a completely new approach to signal analysis and vibration measurement.

A further object of the present invention is to provide a diagnostic and analysis system that allows non-contact and safe measurement of parameters such as all types of leaks, control of all moving parts of the vehicle and vibrations, i.e. all elements that generate sounds or ultrasound.

These objects, as well as others which will become more apparent hereinafter, are obtained by a diagnostic system which, according to claim 1, comprises measuring means suitable for measuring one or more parameters relating to the operation of the components of the vehicle to be tested, said measuring means being suitable for carrying out measurements without contact with the components to be tested, processing means suitable for processing the signals provided by said measuring means and producing the related data, a camera suitable for being superimposed on said components and provided with means for real time detection of sound or ultrasonic signal sources for the generation of an image, a display suitable for reproducing said image, automatic visual reproduction means suitable for superimposing on said image the positions of the sources from which said detected sound or ultrasonic signals originate.

Advantageous embodiments of the invention are obtained in accordance with the dependent claims.

### BRIEF DISCLOSURE OF THE DRAWINGS

Further features and advantages of the object of the invention will become more apparent in light of the detailed description of a preferred but not exclusive embodiment of the system according to the invention, illustrated by way of non-limiting example with the aid of the attached drawing tables wherein:

FIG. 1 is a schematic view of the system in use which illustrates the display modes produced by the system;

FIG. 2 schematically illustrates a possible hardware solution of the system;

FIG. 3 is a graph of the typical response with respect to the frequency;

FIG. 4 is a graph illustrating the response in decibels as a function of frequency;

FIG. 5 is a graph illustrating the relationship between dB SPL in Input and dBV in Output;

FIG. 6 illustrates an example of a three-sensor array;

FIG. 7 illustrates an example of a four-microphone array;

FIG. 8 illustrates a graph relating to the gain of the array;

FIG. 9 illustrates a graph relating to the positioning of a single microphone along the X axis;

FIG. 10 is a graph that illustrates the time delay of the wave front according to a first calculation method;

FIG. 11 is a graph that illustrates the time delay of the wave front calculated according to a further calculation method.

### BEST MODES OF CARRYING OUT THE INVENTION

The system essentially comprises measuring means provided with a plurality of sensors arranged in an array or matrix. Preferably, the sensors are piezoelectric or MEMS sensors.

Furthermore, there is a camera to be positioned centrally on the sensor array to detect signal sources to be superimposed on the image in real time.

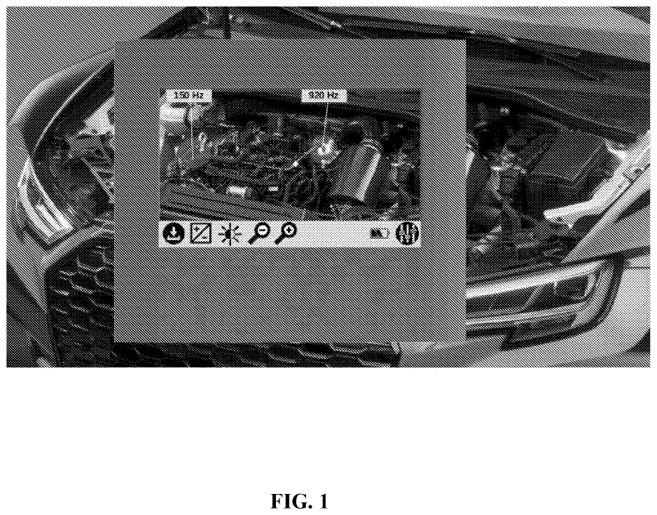

As shown in FIG. 1, the display shows two locations where the sound or ultrasonic signal comes from. The camera automatically detects and displays the signal frequency and the locations where the sound or ultrasonic signal comes from.

The system is also designed to detect other parameters such as noise level, vibration, synchronous or non-synchronous relationships between signal sources, signal non-uniformity, imbalance, looseness, misalignment and bearing failures.

The device will also be adapted to independently track each signal source and detect deviations and present the data on a graph to get a report on how the source has changed over time.

The system also involves the use of appropriate algorithms to process the signal received from the piezoelectric or MEMS sensor array.

The analysis of solutions will begin with the problem of beamforming from piezoelectric receivers, which is a complex and extensive topic. Different concepts and configurations such as array configurations including summing arrays and differential focusing arrays, spatial and frequency responses, and advantages and disadvantages of different array configurations must be considered.

Directionality describes the pattern in which the output level of a microphone or array changes as the sound source changes position in the anechoic space. In theoretical terms, we can assume that we are most interested in omnidirectional receivers, which are equally sensitive to sound coming from all directions regardless of the orientation of the receiver. From the design requirements, however, it can be deduced that for the purposes of this project a directivity range of 60°-90° is probably sufficient. In this range, therefore, we should have constant sensitivity, while in the remaining range the sensitivity should be as low as possible, achievable using an appropriate mechanical solution.

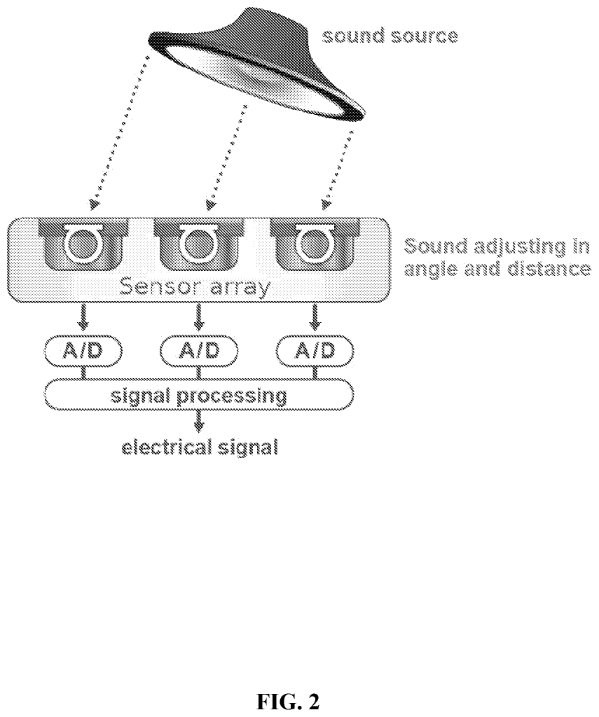

FIG. 2 shows a typical hardware solution of the system wherein it is possible to distinguish several basic blocks, in particular an array of sensor receivers together with a signal amplification block, an ADC block together with appropriate anti-aliasing filters.

Signal processing may be a software solution using an FPGA chip, a microprocessor, or a chip like Nvidia Jetson. The first prototype will be created using a three-core processor from the STM32MP1 family, which will contain two 800 Mhz Cortex A7 cores and one 209 Mhz Cortex M4 core.

Although this solution could be an optimal choice, considering the capacity/price ratio, other solutions could be considered, for example if the STM32MP1 chip proves insufficient to create adequate signal processing to extract the necessary properties from the provided signals.

Again by way of example, the ICS-40730 MEMS chips were selected as input sensors for the first prototype which, due to their properties, are dedicated to sensor array applications.

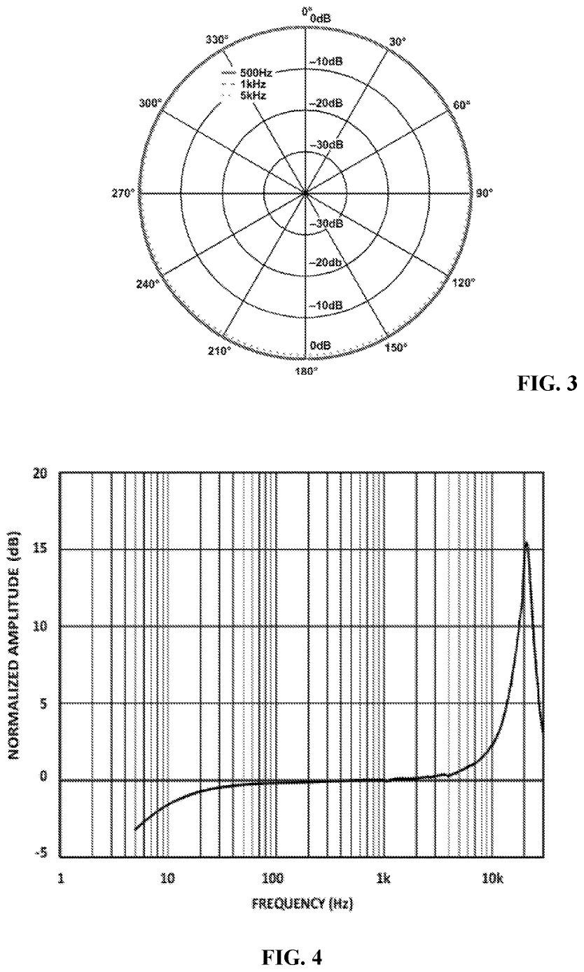

The plot of typical response versus frequency is shown in FIG. 3, where you can see that these circuits are omnidirectional.

Since the system requires directional properties, a mechanical housing design will be created to provide a chip with the necessary sensitivity in the required range.

The ICS-40730 MEMS chip has an extended frequency response from 6 Hz to 20 kHz, as shown in FIG. 4. The ICS-40300 has a linear response up to 130 dB SPL and offers low-frequency extension up to 6 Hz, resulting in excellent phase characteristics in the audio range. Low power consumption allows for long battery life for portable applications.

The signal-to-noise ratio (SNR) specifies the ratio between a reference signal and the noise level of the output sensor. This measurement includes noise provided by both the sensor element and the ASIC embedded in the MEMS package.

Another important parameter is the equivalent input noise (EIN) which is the sensor output noise level, expressed in dB SPL, as a theoretical external noise source placed at the sensor input.

Input SPLs below the EIN level are below the noise floor of the sensor and outside the dynamic range of the signals for which the sensor produces an output.

EIN can be derived from dynamic range or SNR specification as follows:
EIN=acoustic overload point−dynamic range
EIN=94 dB−SNR

The EIN of a sensor with 62 dB SNR and 120 dB acoustic overhead is 32 dB SPL, approximately the SPL that would be generated by a soft whisper in a quiet library at a distance of 5 meters.

SNR is the difference in decibels between the noise level and a standard 1 kHz, 94 dB SPL reference signal. SNR is calculated by measuring the noise output of the sensor in a quiet, anechoic environment. This specification is typically presented over a 20 kHz bandwidth as an A-weighted (dBA) value, meaning it includes a correction factor that corresponds to the sound sensitivity of the human ear at different frequencies.

When comparing SNR measurements from different sensors, it is important to ensure that the specifications are presented using the same weighting and bandwidth; a narrow bandwidth measurement makes the SNR specification better than it is with a full 20 kHz bandwidth measurement. The ICS-40300 MEMS chip has a very good SNR of 63 dBA, which gives us almost studio quality received signals.

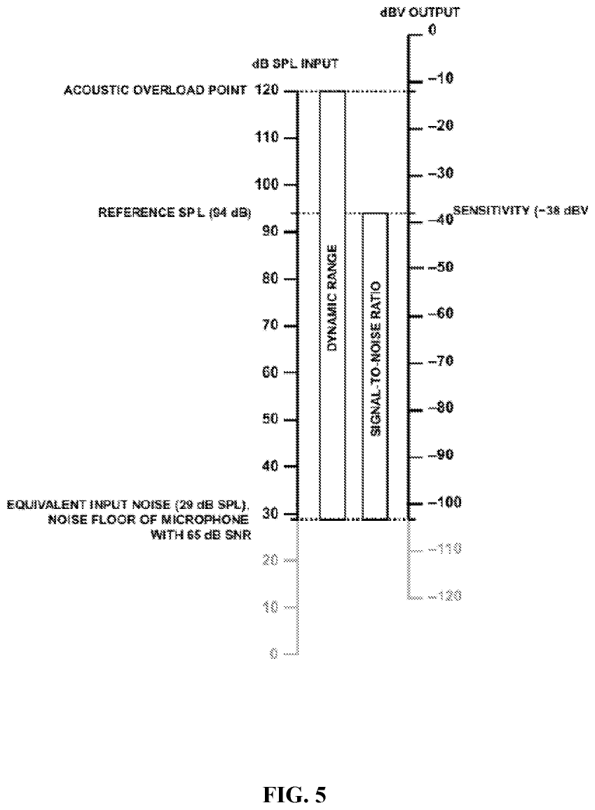

FIG. 5 shows the EIN of the microphones. The ICS-40300 MEMS chip has a good EIN of 31 dBA SPL.

The beamforming effect can be achieved using a linear array of sensors.

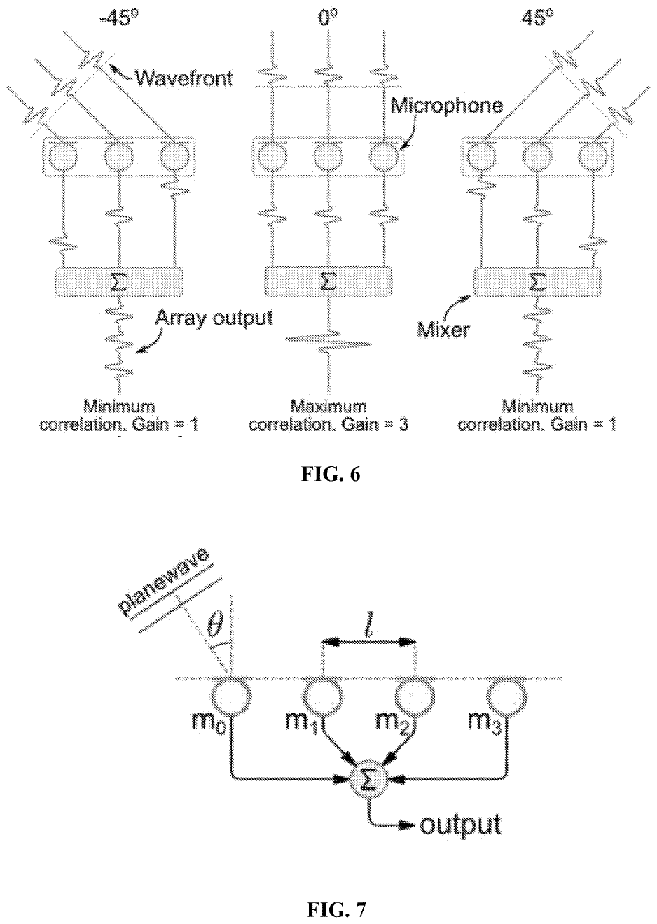

An example of an array having three sensors is shown in FIG. 6, where it can be seen that the direction from which a wavefront originates has an effect on when the signal encounters each element of the array. Arriving from −45° the signal reaches the left sensor first, when it arrives from perpendicular to the array (called broadside) the signal reaches each sensor simultaneously and when from +45° the right sensor receives the signal as first.

If the array output is created by summing all sensor signals, the maximum output amplitude is reached when the signal comes from a source perpendicular to the array; the signals arrive at the same time, are highly correlated over time, and reinforce each other.

Alternatively, if the signal comes from a non-perpendicular direction, it will arrive at different times, so it will be less correlated and will result in a lower output amplitude.

A simple calculation may be used to determine the sensitivity of a microphone array to signals coming from a particular direction.

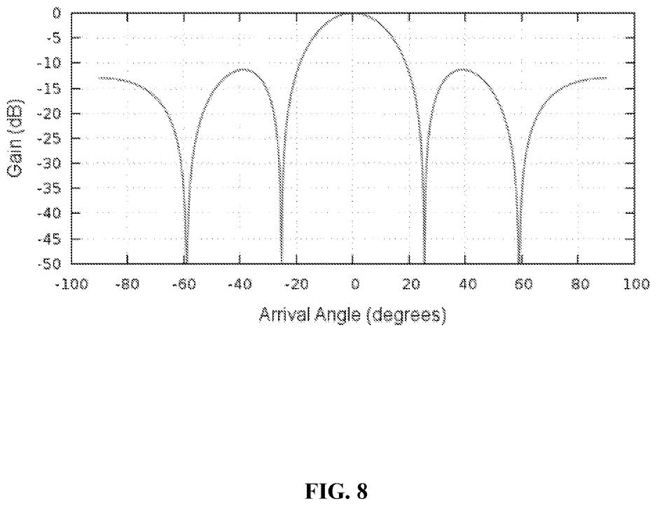

FIG. 7 shows a four-microphone array where each microphone is separated by a predefined distance, for example one meter. The angle of arrival is measured from the perpendicular to the array. Equation (1) below calculates the array gain for a single frequency f and an arrival angle θ, where c denotes the speed of sound and N is the number of microphones.

$$output = 20 {log}_{10} ( \frac{1}{N} {\sum }_{i = 0}^{N - 1} \text{?} )$$

$$\text{?} \text{indicates text missing or illegible when filed}$$

The equation is based on a few assumptions: the signal source is far enough from the array so that the wavefront is effectively flat; furthermore, the attenuation of the signal as it travels from the source to the sensors is not taken into account.

The gain of the array is shown in the graphs of FIG. 8, where the output is normalized to the output that would be received from a single sensor. Therefore, at a 0 degree (wide) angle the output amplitude is equivalent to an omnidirectional sensor, resulting in a gain of 1 (or 0 dB).

Delay calculation is one of the algorithms designed to achieve one of the purposes of the invention.

Solutions that use basic geometric methods and algorithms with windowing function can be used, which will be much better and more precise since they will be immune from small disturbances and from the design of the circuit itself, which will have to take on some measurement time drift if only to temperature differences.

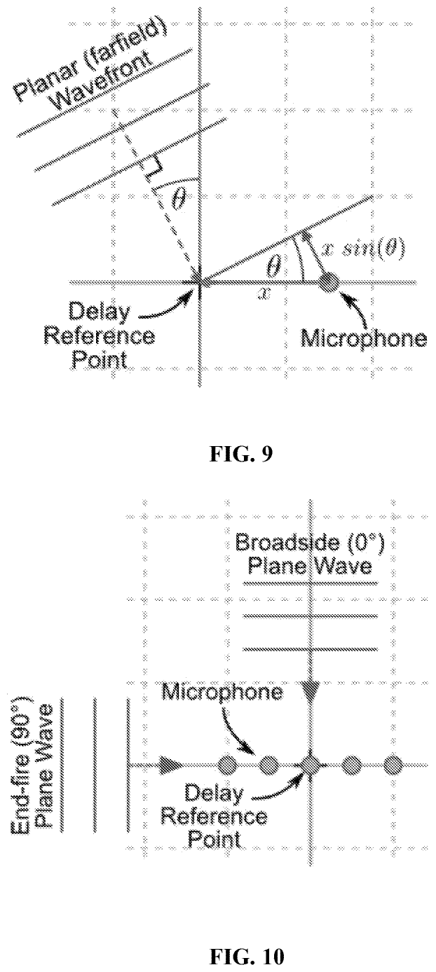

FIG. 9 refers to a basic geometric method and shows a single microphone positioned along the x-axis. This reflects the location of a single element for a 1D array, as in FIG. 10.

In this configuration, the arrival angle of the plane wave is measured from the y-axis; the 0° angle is the lateral plane wave, the ±90° angle is the final focus.

All delay measurements are made with respect to a single point, in this case the origin of the axis.

$$Distance = x sin ( θ )$$

$$Delay = \frac{Distance}{Velocity} = \frac{x sin ( θ )}{Speed of sound}$$

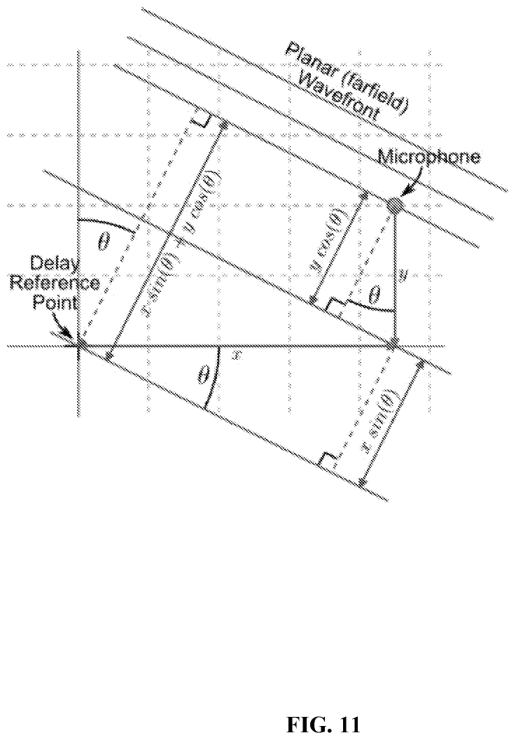

In the case of FIG. 11, the same basic approach is used: the difference in distance that the wave front must travel between the origin and the element is calculated, then it is divided by the speed of sound. This time, however, the distance calculation applies to the 2D case.

$$Distance = x sin ( θ ) + y cos ( θ )$$

$$Delay = \frac{Distance}{Velocity} = \frac{x sin ( θ ) + y cos ( θ )}{Speed of sound}$$

A tracking algorithm may also be needed because the sound source does not have to be always in the same place and it is necessary to localize the sound source correctly so that the analysis software can distinguish sound sources from each other.

This is especially important when the device operator will hold the device in their hand so that changing the position of the device relative to the object under test does not affect the ability to recognize the sound.

To avoid this problem, you can use a MEMS gyroscope, for which the Kalman cage can be calculated, but this will not provide complete protection because the tested object can also move.

For this purpose, a hybrid solution can be used, i.e. combining the advantages of the gyroscope with tracking algorithms. Tracking algorithms also have their drawbacks, so the hybrid solution seems appropriate, especially given that the tested object should not move much and will rather be small movements, for example those made by a car placed on a bench roller dynamometer.

To correctly select solutions and algorithms, you need to start considering which sound sources will appear in the environment of the object being measured.

In case the system is to be used during vehicle measurements on a chassis dynamometer, this environment will be the source of many sounds which will not be important in the measurement processes and which must be eliminated from the measurement process.

One of the largest adverse sound sources is the vehicle's cooling fan, typically positioned in front of the vehicle, whose rotation speed is controlled to simulate airflow through the vehicle as if it were on the road.

Depending on the test carried out, the areas of the vehicle to be considered will be different.

The cooling fan generates pink noise, so you need to create appropriate algorithms that filter this noise. This noise will also have a negative influence on the measurement itself because its high level could have a negative impact on the sensitivity of the microphone.

Appropriate hardware measures and solutions that reduce this noise mechanically could be considered.

Another source of noise can be vibrations from the refrigeration system. Due to the heat released by the engine and additional equipment installed within the test cell, it is necessary to ventilate or refrigerate (depending on the test requirements) the test cell to avoid significant changes in ambient temperature and humidity.

Finally, for the system to recognize diagnostic problems in the automotive industry, additional features could be added that can recognize different faults or detect items of interest.

To this end, an analyzer can be provided that can extract and detect the necessary data from the data and present it to the operator.

The simplest algorithm is based on a simple Fourier analysis, which allows to set the threshold for detecting a given frequency in the measured signal.

More advanced algorithms are for example: Haar transform, Wavelet, artificial neural networks and Bayesian inference.

The Haar transform is often used in image pattern recognition applications. Machine learning algorithms are used in a large number of applications.

To extract the signal from the noisy environment it will also be necessary to have digital filters that effectively filter the necessary information so that it is suitable for further processing and presentation.

1-10. (canceled)

11. A system for diagnosis on vehicle component, comprising:
measuring means for measuring one or more parameters relating to the operation of the components of the vehicle to be tested, the measuring means having the ability to carry out the measurements without contact with the components to be tested;
processing means for processing the signals provided by the measuring means and producing the related data;
a camera capable of being superimposed on the components and provided with means for real-time detection of sources of sound or ultrasonic signals for the generation of an image;
a display for reproducing the image; and
means of automatic visual reproduction for superimposing on the image the positions of the sources from which the detected sound or ultrasonic signals originate.

12. The system of claim 11, wherein the measuring means include a plurality of sensors arranged in a group arrangement selected from the group consisting of an array and a matrix.

13. The system of claim 12, wherein the sensors are sensors selected from the group consisting of piezoelectric sensors and micro-electromechanical system sensors.

14. The system of claim 12, wherein the camera is arranged to be positioned centrally on the group arrangement selected from the group consisting of an array and a matrix.

15. The system of claim 13, wherein the camera is arranged to be positioned centrally on the group arrangement selected from the group consisting of an array and a matrix.

16. The system of claim 11, wherein the measuring means are suitable for detecting further parameters selected from the group consisting of noise level, vibrations, synchronous relationships between signal sources, non-synchronous relationships between signal sources, signal non-uniformity, imbalance, looseness, misalignment, and bearing failure.

17. The system of claim 12, wherein the measuring means are suitable for detecting further parameters selected from the group consisting of noise level, vibrations, synchronous relationships between signal sources, non-synchronous relationships between signal sources, signal non-uniformity, imbalance, looseness, misalignment, and bearing failure.

18. The system of claim 13, wherein the measuring means are suitable for detecting further parameters selected from the group consisting of noise level, vibrations, synchronous relationships between signal sources, non-synchronous relationships between signal sources, signal non-uniformity, imbalance, looseness, misalignment, and bearing failure.

19. The system of claim 14, wherein the measuring means are suitable for detecting further parameters selected from the group consisting of noise level, vibrations, synchronous relationships between signal sources, non-synchronous relationships between signal sources, signal non-uniformity, imbalance, looseness, misalignment, and bearing failure.

20. The system of claim 15, wherein the measuring means are suitable for detecting further parameters selected from the group consisting of noise level, vibrations, synchronous relationships between signal sources, non-synchronous relationships between signal sources, signal non-uniformity, imbalance, looseness, misalignment, and bearing failure.

21. The system of claim 11, wherein the processing means are also adapted to independently track each signal source and detect deviations and present the data on a graph on the display to obtain a report on how the source has changed over the time.

22. The system of claim 20, wherein the processing means are also adapted to independently track each signal source and detect deviations and present the data on a graph on the display to obtain a report on how the source has changed over the time.

23. The system of claim 11, wherein the processing means have the ability to operate an algorithm for calculating the delay.

24. The system of claim 22, wherein the processing means have the ability to operate an algorithm for calculating the delay.

25. The system of claim 11, wherein the processing means have the ability to use an algorithm for calculating at least one of the wavefront delay of the sound and an ultrasonic signal.

26. The system of claim 24, wherein the processing means have the ability to use an algorithm for calculating at least one of the wavefront delay of the sound and an ultrasonic signal.

27. The system of claim 11, wherein the processing means have the ability to use a sound source tracking algorithm.

28. The system of claim 26, wherein the processing means have the ability to use a sound source tracking algorithm.

29. The system of claim 27, further comprising a micro-electromechanical system gyroscope.

30. The system of claim 28, further comprising a micro-electromechanical system gyroscope.
